(19) United States
(12) Patent Application Publication
(10) Pub. No.: US 2013/0215845 A1
(43) Pub. Date: Aug. 22, 2013

(54) METHOD AND DEVICE FOR GENERATING REFERENCE SIGNAL IN CELLULAR MOBILE COMMUNICATION SYSTEM

(71) Applicant: Samsung Electronics Co., Ltd., (US)

(72) Inventors: Hyojin LEE, Seoul (KR); Younsun KIM, Seongnam-si (KR); Giil KIM, Yongin-si (KR); Hyoungju JI, Seoul (KR); Joonyoung CHO, Suwon-si (KR); Juho LEE, Suwon-si (KR)

(73) Assignee: SAMSUNG ELECTRONICS CO. LTD., Suwon-si (KR)

(21) Appl. No.: 13/770,789

(22) Filed: Feb. 19, 2013

Related U.S. Application Data
(60) Provisional application No. 61/600,192, filed on Feb. 17, 2012.
(60) Provisional application No. 61/615,452, filed on Mar. 26, 2012.

(51) Int. Cl. H04W 72/04

(52) U.S. Cl. CPC H04W 72/048
USPC 370/329; 370/328

(57) ABSTRACT

A method of transmitting a reference signal in a mobile communication system is provided. The method includes determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, generating, if the demodulation reference signal is for more than or equal to 3-layer transmission, the demodulation reference signal sequence using the third scrambling variable and transmitting the demodulation reference signal sequence through a corresponding antenna port.

### CROSS-REFERENCE TO RELATED APPLICATIONS

This application claims the benefit under 35 U.S.C. §119(e) of a U.S. provisional patent application filed on Feb. 17, 2012 in the U.S. Patent and Trademark Office and assigned Ser. No. 61/600,192, and a U.S. provisional patent application filed on Mar. 26, 2012 in the U.S. Patent and Trademark Office and assigned Ser. No. 61/615,452, the entire disclosure of each of which is hereby incorporated by reference.

### BACKGROUND OF THE INVENTION

1. Field of the Invention

The present invention relates to a method and a device for generating a reference signal in a cellular mobile communication system having a plurality of base stations. More particularly, the present invention relates to a method of efficiently generating a reference signal in a Distributed Antenna System (DAS) in which antennas operated by each base station are distributed at a service area of a corresponding base station, and a device thereof.

2. Description of the Related Art

A mobile communication system according to the related art provides a voice-oriented service. However, a current mobile communication system has been developed to high speed and high quality wireless packet data communication system to provide a voice service, a data service, and a multi-media service. Various mobile communication standards, such as High Speed Downlink Packet Access (HSDPA), High Speed Uplink Packet Access (HSUPA), Long Term Evolution (LTE), LTE-Advanced (LTE-A) of the 3^{rd} Generation Partnership Project (3GPP), High Rate Packet Data (HRPD) of the 3GPP2, and 802.16 of the Institute of Electrical and Electronics Engineers (IEEE) have been developed in order to support a high speed and high quality wireless packet data transmission service. More particularly, an LTE system is a system developed to efficiently support high speed wireless packet data transmission. The LTE system may maximize capacity of a wireless system using various warless access technologies. The LTE-A system is an evolved wireless system of an LTE system and has improved data transmission performance compared to the LTE system.

A 3G wireless packet data communication system, such as HSDPA, HSUPA, and HRPD uses an Adaptive Modulation and Coding (AMC) scheme and a channel reply scheduling scheme to improve transmission efficiency. When the AMC scheme is used, a transmitter may control transmitted data according to a channel state. For example, if the channel state is not excellent, the transmitter may reduce the amount of the transmitted data to reduce a reception error probability to a desired level. If the channel state is excellent, the transmitter may increase the amount of the transmitted data to efficiently transmit a large amount of information while maintaining a reception error probability to a desired level. When a channel reply scheduling resource management method is applied, a transmitter selectively provides a service to a user having an excellent channel state among a plurality of users. Accordingly, available system capacity in the channel reply scheduling scheme is increased compared to a scheme of allocating a channel to serve one user. Such capacity increase refers to a multi-user diversity gain. According to the AMC scheme and the channel reply scheduling scheme, a transmitter may receive feedback of partial channel state information and apply a suitable modulation and coding scheme at the most efficiently determined time point.

When the AMC scheme is used together with a Multiple Input Multiple Output (MIMO) transmission scheme, it may include a function of determining the number of spatial layers of a transmitted signal or a rank. In this case, the wireless packet data communication system to which the AMC scheme is applied simply considers a code rate and a modulation scheme to determine an optimal data transmission rate and a number of transmission layers using the MIMO.

In recent years, research has been actively performed to convert the Code Division Multiple Access (CDMA) scheme, which is a multiple access scheme used in 2G and 3G mobile communication systems, to an Orthogonal Frequency Division Multiple Access (OFDMA) scheme, which is a next generation system. 3GPP and 3GPP2 have begun to standardize an evolved system using OFDMA. It is known in the art that capacity increase is expected in an OFDMA scheme compared to a CDMA scheme. One of various reasons causing capacity increased in the OFDMA scheme is that a frequency domain scheduling may be performed in a frequency axis. As a capacity gain is acquired through the channel replay scheduling scheme due to channel change characteristic according to time and when a channel is changed according to a frequency, a higher capacity gain can be obtained.

In a case of the related art, a cellular mobile communication system having a plurality of cells is established as illustrated in FIG. 1 to provide a mobile communication service using the various schemes.

FIG. 1 illustrates a cell structure having three cells where transceiving antennas are arranged in centers of the cells, respectively, in a cellular mobile communication system according to the related art.

Referring to FIG. 1, the cellular mobile communication system includes three cells, that is, a cell 100, a cell 110, and a cell 120, and reference numeral 160 illustrates the cell structure of the cell 100. The cell 100 includes a centrally located antenna(s) 130, a User Equipment 1 (UE1) 140, and a UE2 150 as illustrated in the cell structure 160. The antenna 130 provides a mobile communication service to two UEs located in the cell 100. Since the UE1 140 receiving the mobile communication service using the antenna 130 is located away from the antenna 130 compared to the UE2 150, transmission speed of supportable data is relatively low.

As shown in FIG. 1, antennas of respective cells 100 have a form of a Central Antenna System (CAS) arranged at a center of a corresponding cell. In a case of the CAS, although a plurality of antennas are arranged in every cell, the antennas are arranged at the center of the cell so that communication with respect to a service area of the cell is performed. As shown in FIG. 1, when antennas by cells are arranged and operated in the form of the CAS in the cellular mobile communication system, in order to measure a downlink channel state for each cell or demodulate a downlink signal, a reference signal needs to be transmitted. In a case of a 3GPP LTE-A system, a UE estimates channel information used to demodulate the downlink signal, and measures a channel state between the UE and a base station using a Channel Status Information Reference Signal (CSI-RS) transmitted by the base station.

FIG. 2 illustrates a location of a CSI-RS which a base station transmits to a UE in an LTE-A system according to the related art.

Referring to FIG. 2, a signal with respect to four Demodulation-Reference Signal (DM-RS) ports in each location corresponding to reference numerals 220 and 221 may be transmitted. For example, signals with respect to DM-RS ports 7, 8, 11, 13 are transmitted to a location corresponding to the reference numeral 220, and signals with respect to DM-RS ports 9, 10, 12, 14 are transmitted to a location corresponding to the reference numeral 221. Different DM-RS ports corresponding to the same location are identified through a Code Division Multiplexing (CDM) scheme. Codes allocated to the DM-RS ports are defined as illustrated in Table 1.

TABLE 1

| Antenna port ^{p} | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

FIG. 3 illustrates a mapping scheme of a sequence index with respect to (x) DM-RS resources per Resource Block (RB) by DM-RS ports as a frequency preference mapping scheme according to the related art.

Referring to FIG. 3, a mapping scheme of a sequence index with respect to 12 DM-RS resources per RB by DM-RS ports is illustrated as a frequency preference mapping scheme.

A DM-RS sequence transmitted from locations of DM-RS ports is defined by Equation 1.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{m ax , DL} - 1 \qquad Equation 1$$

In Equation 1, N_{RB}^{max,DL} indicates the number of RBs available in a downlink signal and m indicates an index of a sequence. The c(i) is a pseudo-random sequence, and an initial value with respect to a generator of the pseudo-random sequence is defined as illustrated in Equation 2.

cᵢₙᵢₜ=(└nₛ/2┘1)·(2N_{ID}^{cell}+1)·2¹⁶+n_{SCID} Equation 2

In Equation 2, N_{ID}^{cell} represents a cell ID, and n Service Channel IDentifier (nSCID) represents scrambling identity information, and is determined as 0 or 1 by a scrambling identity field in a Data Character Identifier (DCI) format 2B or 2C transferred through a Physical Downlink Control Channel (PDCCH). For example, antenna ports in the same cell have the same cell ID, and two types of DM-RS sequences for each antenna port are identified by nSCID.

Referring again to FIG. 2, a signal with respect to two CSI-RS antenna ports in each location of reference numerals 200 to 219 may be transmitted. For example, the base station transmits two CSI-RSs for measuring downlink to the UE from a location 200. As shown in FIG. 1, in a case of a cellular mobile communication system having a plurality of cells, locations to which CSI-RS is transmitted may be allocated differently according to cells. For example, in a case of a cell 100 shown in FIG. 1, a CSI-RS may be transmitted from the location 200 in a case of the cell 100 shown in FIG. 1, from the location 205 in a case of the cell 110, and from the location 210 in a case of the cell 120. As described above, a resource for CSI-RS transmission is allocated in different locations with respect to respective cells to prevent CSI-RSs of different cells to cause mutual interference.

A CSI-RS sequence transmitted from locations of CSI-RS antenna ports is defined by Equation 3.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{m ax , DL} - 1 \qquad Equation 3$$

In Equation 3, c(i) is a pseudo-random sequence, and an initial value with respect to a generator of the pseudo-random sequence is defined as illustrated in Equation 4.

cᵢₙᵢₜ=2¹⁰·(7·(nₛ+1)+l+1)·(2·N_{ID}^{cell}+1)+2·N_{ID}^{cell}+N_{CP} Equation 4

In Equation 4, 1 notes an Orthogonal Frequency Division Multiplexing (OFDM) symbol order in one slot, and N_{CP} is determined with 0 or 1 according to a length of a Cyclic Prefix (CP) used in a cell.

When using a CAS scheme shown in FIG. 1, as transceiving antennas are centrally located at the cell, there is limitation in supporting a high transmission rate to a UE spaced apart from the center of the cell. For example, in the CAS, providing a high speed data transmission rate to UEs existing in a cell is greatly affected according to where the UE is in the cell. Accordingly, in the cellular mobile communication system, a UE located relatively close to a cell center may transmit and receive data with a high transmission rate. A UE located in a remote location may not transmit and receive data with high transmission rate.

Therefore, a need exists for a method and a device for generating a reference signal in a cellular mobile communication system having a plurality of base stations.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide devices and methods for transmitting and receiving a demodulation reference signal.

In accordance with an aspect of the present invention, a method of transmitting a reference signal in a mobile communication system is provided. The method includes determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, generating, if the demodulation reference signal is for more than or equal to 3-layer transmission, the demodulation reference signal sequence using the third scrambling variable and transmitting the demodulation reference signal sequence through a corresponding antenna port.

In accordance with another aspect of the present invention, a method of receiving a reference signal by a User Equipment (UE) in a mobile communication system is provided. The method includes determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, generating, if the demodulation reference signal is for more than or equal to 3-layer transmission, the demodulation reference signal sequence using the third scrambling variable, and receiving a demodulation reference signal using the demodulation reference signal sequence through a corresponding antenna port.

In accordance with still another aspect of the present invention, an apparatus for transmitting a reference signal in a mobile communication system is provided. The apparatus includes a controller for determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, and generating, if the demodulation reference signal is for more than or equal to 3-layer transmission, the demodulation reference signal sequence using the third scrambling variable, and a transmitting unit for transmitting the demodulation reference signal sequence through a corresponding antenna port.

In accordance with yet another aspect of the present invention, a UE for receiving a reference signal in a mobile communication system is provided. The UE includes a controller for determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, and generating, if the demodulation reference signal is for more than or equal to 3-layer transmission, the demodulation reference signal sequence using the third scrambling variable, and a receiving unit for receiving a demodulation reference signal using the demodulation reference signal sequence through a corresponding antenna port.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a cell structure having three cells where transceiving antennas are arranged in centers of the cells, respectively, in a cellular mobile communication system according to the related art;

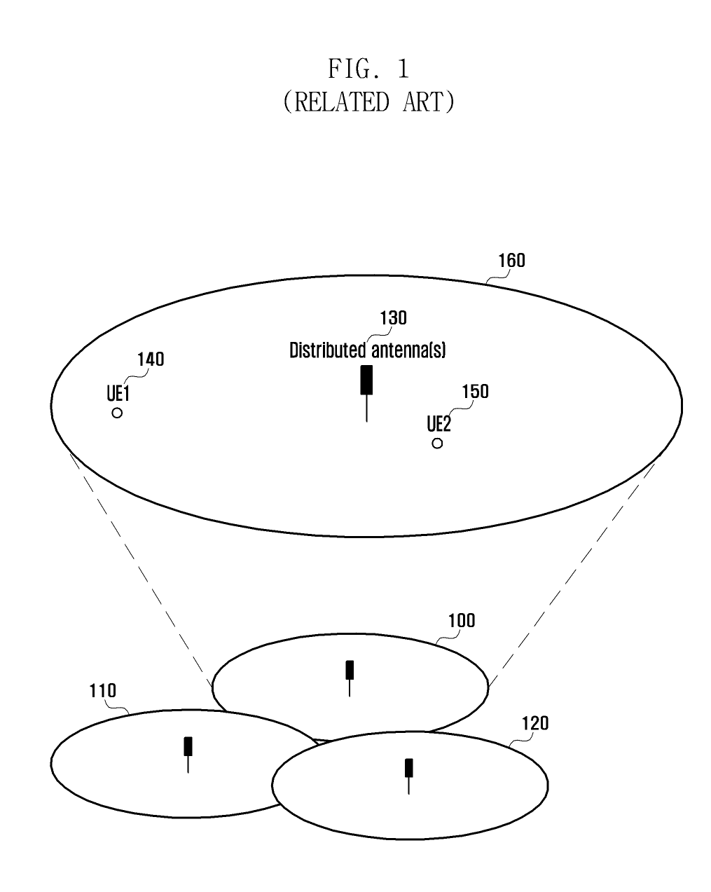

FIG. 2 illustrates a location of a Channel Status Information-Reference Signal (CSI-RS) which a base station transmits to a User Equipment (UE) in a Long Term Evolution-Advanced (LTE-A) system according to the related art;

FIG. 3 illustrates a mapping scheme of a sequence index with respect to (x) Demodulation-Reference Signal (DM-RS) resources per Resource Block (RB) by DM-RS ports as a frequency preference mapping scheme according to the related art;

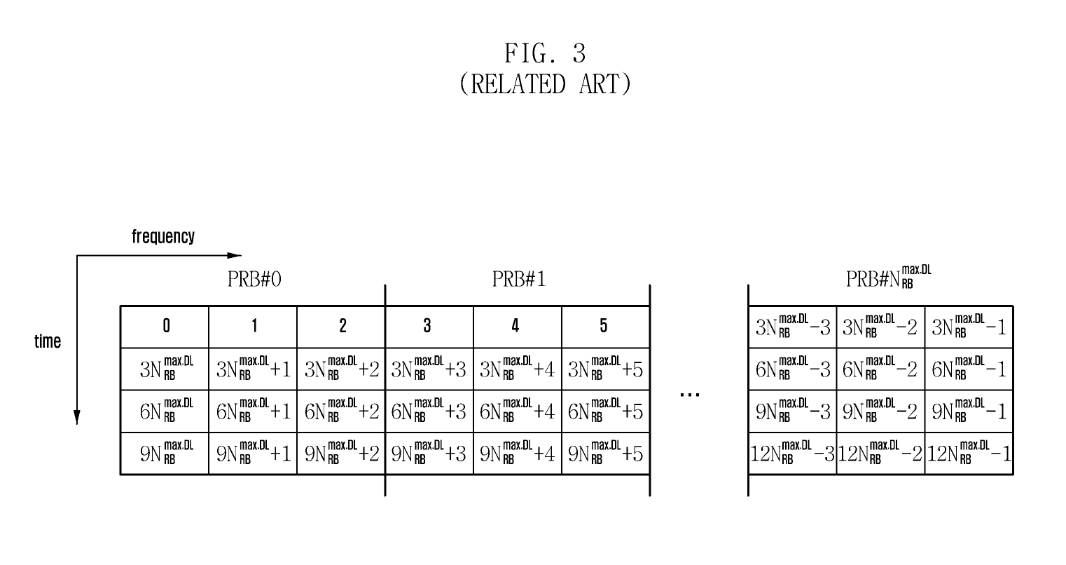

FIG. 4 illustrates a configuration of a distributed antenna system where transceiving antennas are distributed for each cell in a cellular mobile communication system according to an exemplary embodiment of the present invention;

FIG. 5 illustrates a procedure of generating a DM-RS signal according to an exemplary embodiment of the present invention;

FIG. 6 is a flowchart illustrating a procedure of generating a DM-RS sequence of a base station according to a first exemplary embodiment of the present invention;

FIG. 7 is a flowchart illustrating a procedure of generating a DM-RS sequence of a base station according to a second exemplary embodiment of the present invention;

FIG. 8A is a flowchart illustrating a procedure of generating a DM-RS sequence of a base station according to a third exemplary embodiment of the present invention;

FIG. 8B is a flowchart illustrating a procedure of generating a DM-RS sequence of a base station according to a fifth exemplary embodiment of the present invention;

FIG. 9A is a block diagram illustrating a device for generating a DM-RS sequence of a base station according to an exemplary embodiment of the present invention;

FIG. 9B is a block diagram illustrating a structure of a UE according to an exemplary embodiment of the present invention; and

FIG. 10 is a flowchart illustrating a procedure of generating DM-RS in consideration of switching with respect to applications of new scrambling and existing scrambling according to the first exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention relate to a wireless communication system based on Orthogonal Frequency Division Multiplexing (OFDM), more particularly, 3^{rd} Generation Partnership Project (3GPP) Evolved Universal Terrestrial Radio Access (EUTRA).

In general, a cellular wireless mobile communication system is achieved by establishing a plurality of cells at a limited zone. In each cell, a base station for controlling mobile communication in a corresponding cell is located at the center of the call area. The base station includes an antenna for transmitting a wireless signal and a signal processing part, and provides a mobile communication service to User Equipments (UEs) in a cell in a center of the cell. As described above, a system installed at the center of the cell refers to a Centralized Antenna System (CAS), and a general mobile communication system has the form of the CAS.

A Distributed Antenna System (DAS) is on the contrary to the CAS. The DAS may provide an improved mobile communication service compared to the CAS by uniformly distributing antennas at a service area of a base station.

Exemplary embodiments of the present invention relate to a DAS distributed and arranged at a service zone of each base station, which efficiently generates a reference signal in the DAS, thereby maximizing an RS resource in the DAS. For example, exemplary embodiments of the present invention provide a method of generating a Demodulation-Reference Signal (DM-RS) suitable for the DAS for efficiently operating distributed antennas in a DAS in which antennas operated by each base station are distributed at a service area of a corresponding base station in a cellular mobile communication system having a plurality of base stations, and a device thereof.

As described above, in the CAS, high speed data transmission rate to UEs existing in a cell is greatly affected according to the location of the UE in the cell. Accordingly, a UE located relatively close to a cell center may transmit and receive data with a high transmission rate. A UE located in a remote location has difficulty in transmitting and receiving data with high transmission rate. Exemplary embodiments of the present invention may address the forgoing problems by establishing the cellular mobile communication system in the form of the DAS.

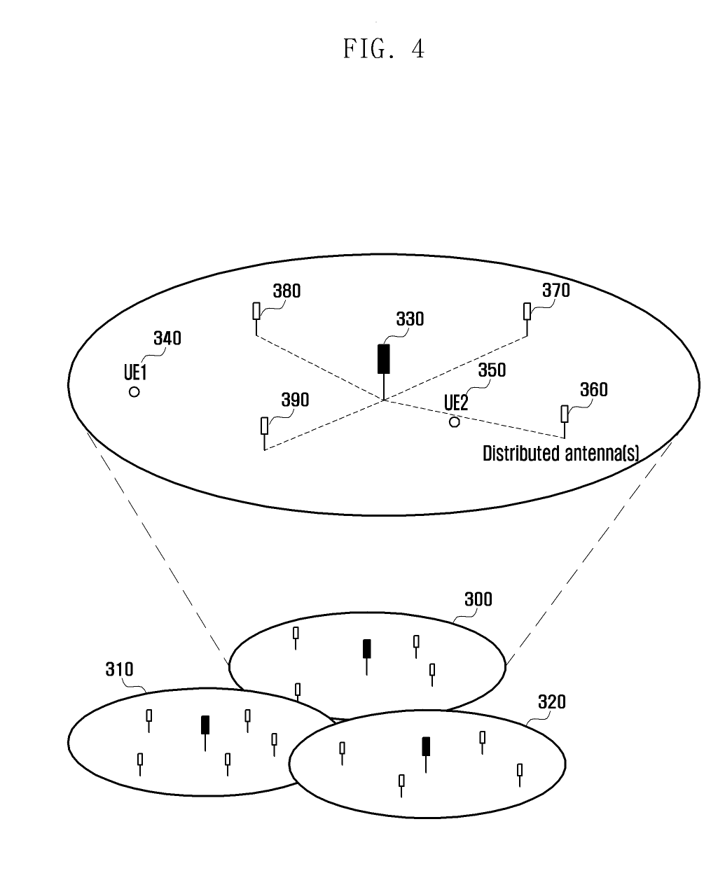

FIG. 4 illustrates a configuration of a mobile communication system according to an exemplary embodiment of the present invention. In this case, it is assumed that the mobile communication system of the exemplary embodiment is configured by three cells. FIG. 4 illustrates that a base station is located at the center of each service area, and antennas of a base station are distributed at entire service areas of each base station.

Referring to FIG. 4, the mobile communication system is configured by a plurality of cells 300, 310, and 320. A central antenna 330 is located at the center of each of cells 300, 310, and 320, and a plurality of distributed antennas 360, 370, 380, and 390, a first UE 340, and a second UE 350 are distributed at entire service areas of the cells 300, 310, and 320. Respective cells 300, 310, and 320 may be configured by small cells of the central antenna 330 and distributed antennas 360, 370, 380, 390. In this case, the cells 300, 310, and 320 are operated according to one cell IDentification (ID). The central antenna 330 and the distributed antennas 360, 370, 380, and 390 in the cells 300, 310, and 320 have the same cell ID. The first UE 340 and the second UE 350 receive a mobile communication service from a base station through at least one communication antenna selected from the central antenna 330 and the distributed antennas 360, 370, 380, and 390 for uplink or downlink transmission.

For example, the first UE 340 may receive a mobile communication service from a base station through distributed antennas 380 and 390 close to the first UE 340, and the second UE 350 may receive the mobile communication service from the base station through the central antenna 330. When the mobile communication system supports the CAS and the first UE 340 is located away from the central antenna 330, data transmission speed relatively decreases. However, when the mobile communication system supports the DAS, the first UE 340 may receive data transmission of relatively high speed through adjacent distributed antennas 380 and 390.

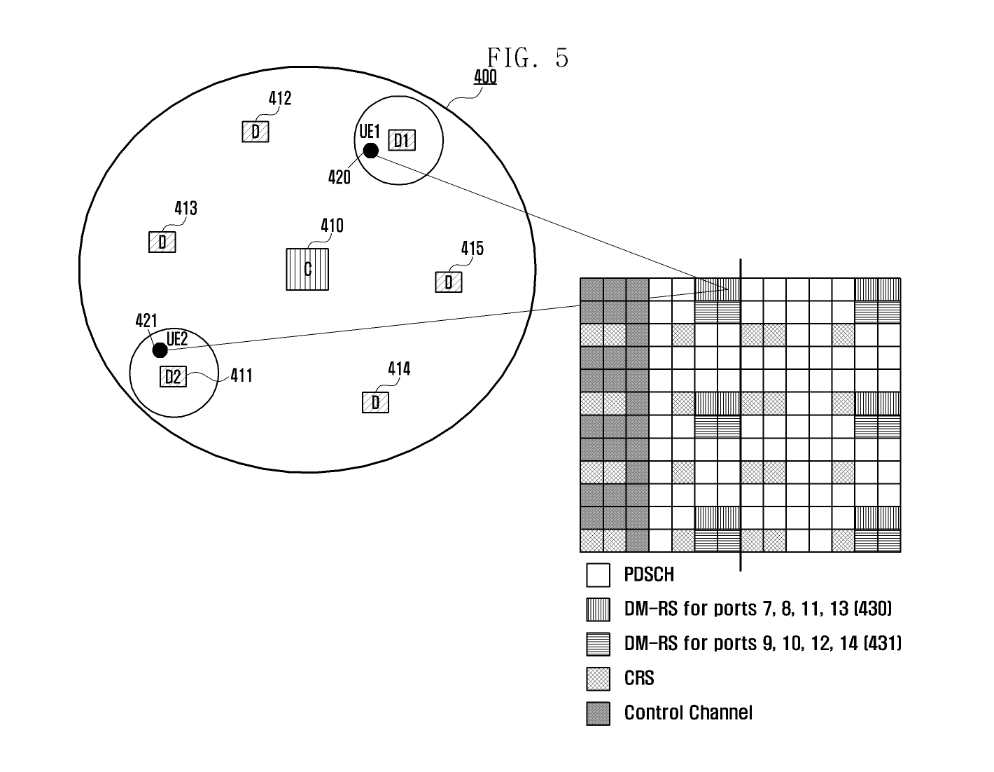

FIG. 5 illustrates a procedure of generating a DM-RS signal according to an exemplary embodiment of the present invention.

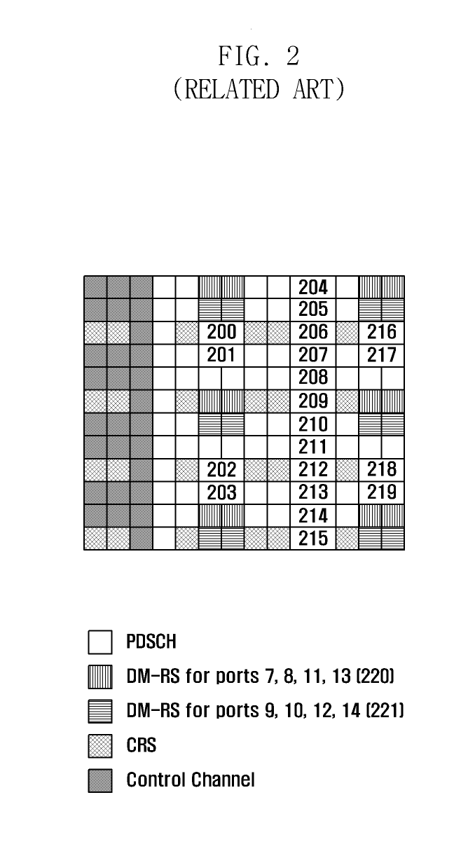

Referring to FIG. 5, a central antenna 410 of a base station is arranged at a center of the cell 400 using the DAS, and distributed antennas 410, 411, 412, 413, 414, and 415 of the base station are distributed at a full service area. It is assumed that the UE1 420 receives downlink information through the distributed antenna 410, and the UE2 421 receives downlink information through the distributed antenna 411. Similar to the signal transmission illustrated in FIG. 2, a signal with respect to four DM-RS ports in each location 430 and 431 may be transmitted. For example, signals with respect to DM-RS ports 7, 8, 11, 13 are transmitted to a location 430, and signals with respect to DM-RS ports 9, 10, 12, 14 are transmitted to a location 431. It is assumed that the base station determines that downlink information with respect to two UEs is transmitted through each distributed antenna in the same Resource Block (RB) at the same time. In this case, if the DM-RS sequence is applied to Equation 1 as in the Long Term Evolution-Advanced (LTE-A), two UEs having received downlink information through the same RB with respect to the same n_{SCID} use a corresponding DM-RS resource and sequence so that the DM-RSs interfere with each other. Accordingly, if an LTE-A downlink DM-RS transmitting method designed in consideration of the CAS is applied to the DAS in the LTE-A system, the resource may not be efficiently used. There is a need for an improved method of generating and transmitting a downlink DM-RS so that the same RB may be allocated to UEs using different distributed antennas.

The following is a description of an exemplary method of generating a downlink DM-RS for the DAS such that information about a plurality of UEs may be simultaneously transmitted to the same RB through a plurality of antennas among the central antenna or the distributed antennas by the base station through first, second, third, and fourth exemplary embodiments.

In this case, the method of generating the DM-RS according to the first, second, and third exemplary embodiments identifies a DM-RS by adding DM-RS sequence using at least two scrambling variables. For example, the base station determines at least two scrambling variables for each UE corresponding to antennas distributed at a corresponding service area. The base station combines scrambling variables with each other to generate a DM-RS sequence for each antenna. Furthermore, the base station transmits the DM-RS sequence through each antenna.

### First Exemplary Embodiment

In the method of generating a DM-RS according to the first exemplary embodiment of the present invention, scrambling using a unique number of a UE allocated to a base station as well as scrambling of a DM-RS sequence according to n_{SCID} in Equation 1 is introduced. Accordingly, in a case of the DAS, more various DM-RS may be used compared to a case of the CAS. For example, the DM-RS sequence according to the first exemplary embodiment is generated as illustrated in Equation 5.

$$r ( m ) = \frac{1}{\sqrt{2}} ( 1 - 2 \cdot c ( 2 m ) ) + j \frac{1}{\sqrt{2} } ( 1 - 2 \cdot c ( 2 m + 1 ) ) , \\ m = 0 , 1 , … , 12 {N}_{RB}^{m ax , DL} - 1 \qquad Equation 5$$

In Equation 5, c(i) is a pseudo-random sequence, and an initial value with respect to a generator of the pseudo-random sequence is defined as illustrated in Equation 6.

cᵢₙᵢₜ=(└nₛ/2┘+1)·(2N_{ID}^{cell}+1)·2¹⁶+f(n_{SCID},[n_{RNTI} mod G]) Equation 6

In Equation 6, G represents the number of sequences to be added using n_{RNTI} and ƒ(a,b) is a function which has a of 0 or 1 and b from 0 to G−1 as inputs, and outputs 2×G different values. In Equation 6, ƒ(n_{SCID},[n_{RNTI} mod G])=[n_{RNTI} mod G]·2+n_{SCID} may be considered by way of example. This is an exemplary method which considers the fact that the n_{SCID} has 0 or 1 and may sufficiently ensure a possible G value. This exemplary method is generalized so that ƒ(n_{SCID},[n_{RNTI} mod G]) may be set to [n_{RNTI} mod G]·2ⁿ+n_{SCID}, and n is less than 16. A reason why mod G is applied to an initial value is because interference measurement is easy by limiting the number of DM-RSs for different UEs in the same RB. If the G is increased, the number of simultaneously usable DM-RSs is increased but interference measurement is complicated and uncertain. The G is a preset value in advance, and a central base station may report the G to UEs in the cell through a broadcasting channel.

If an initial scrambling value as illustrated in Equation 6 is newly used, existing developed LTE Release 9 or 10 UEs do not recognize new scrambling. Accordingly, as listed in Table 1, although the UE applying new scrambling and the existing UEs are allocated to a port 7 and a port 8 using orthogonal sequences, the orthogonality is not ensured due to different scrambling. Accordingly, there is a demand to design a method of ensuring the orthogonality of the port 7 and the port 8 with respect to the existing UEs and new UEs to efficiently support a Multi-User Multiple Input Multiple Output (MU-MIMO) operation. To this end, in a state that the UE applying the new scrambling operates as MU-MIMO with the existing UEs, existing scrambling is applied. Otherwise it may be considered that dynamic switching applying the new scrambling is possible. Scrambling is applicable by adding a bit indicating whether to use which one of the existing scrambling and the new scrambling in downlink control information transmitted through a downlink control channel. The new scrambling has an initial value resulting from Equation 6 and the existing scrambling has an initial value resulting from Equation 2. Information regarding whether to apply the new scrambling may be included in control information for resource allocation and downlink scheduling for determining Modulation and Coding Scheme (MCS).

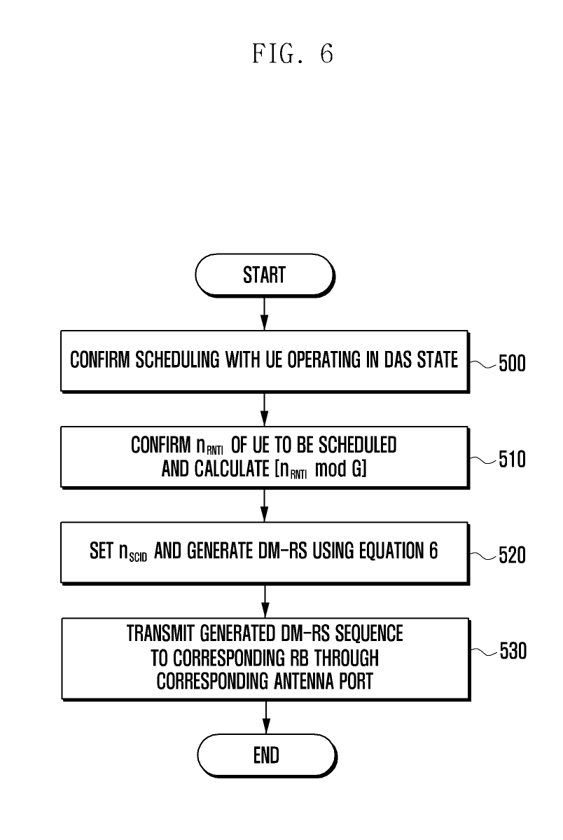

FIG. 6 is a flowchart illustrating a procedure of generating a DM-RS sequence of a base station according to a first exemplary embodiment of the present invention.

Referring to FIG. 6, a base station confirms scheduling with a UE operating in a DAS state at step 500. For example, the base station confirms UEs to be scheduled corresponding to antennas, respectively. The base station confirms n_{RNTI} of the UE to be scheduled and calculates [n_{RNTI} mod G] at step 510. For example, the base station determines [n_{RNTI} mod G] as a scrambling variable using n_{RNTI} of the UE and the mod G. Thereafter, the base station sets n_{SCID} and generates a DM-RS sequence for a corresponding UE using Equation 6 at step 520. In this case, the n_{SCID} is set in consideration of n_{RNTI} values of other UEs to be scheduled in the same RB so that collision is prevented. For example, the base station determines n_{SCID} as the scrambling variable. The base station combines the [n_{RNTI} mod G] with the n_{SCID} to generate the DM-RS sequence for a corresponding UE. The base station transmits the generated DM-RS sequence to a corresponding RB through a corresponding antenna port at step 530 and a procedure of generating and transmitting the DM-RS is terminated. With respect to this, the UE estimates a channel in consideration of new scrambling applying [n_{RNTI} mod G] and receives downlink data.

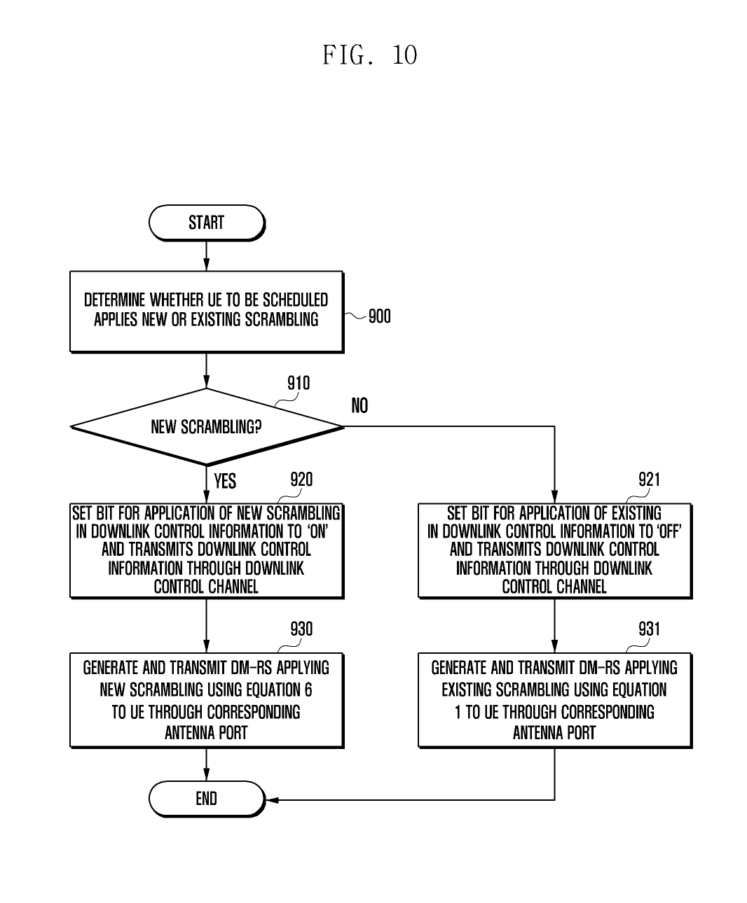

FIG. 10 is a flowchart illustrating a procedure of generating DM-RS in consideration of switching with respect to applications of new scrambling and existing scrambling according to the first exemplary embodiment of the present invention.

Referring to FIG. 10, a base station determines whether a UE to be scheduled applies new scrambling or existing scrambling at step 900. When the UE to be scheduled applies the new scrambling at step 910, the base station sets a bit for application of the new scrambling in downlink control information to ‘ON’ to report the application of the new scrambling to the UE, and transmits the information through downlink control channel at step 920. Thereafter, the base station generates and transmits a DM-RS applying the new scrambling using Equation 6 for each RB to the UE through a corresponding antenna port together with downlink data at step 930. When the UE to be scheduled applies the existing scrambling at step 910, the base station sets a bit for application of the new scrambling in downlink control information to ‘OFF’ to report the application of the existing scrambling to the UE, and transmits the information through downlink control channel at step 921. Thereafter, the base station generates and transmits a DM-RS applying the existing scrambling using Equation 1 for each RB to the UE through a corresponding antenna port together with downlink data at step 931. Then, the UE confirms the bit for application of the new scrambling in the downlink control information. If the bit is set to ‘ON’, the UE receives a DM-RS using Equation 6 to estimate a channel and restores data. If the bit is set to ‘OFF’, the UE receives a DM-RS using Equation 1 to estimate the channel and restores the data.

### Second Exemplary Embodiment

In the method of generating a DM-RS according to the second exemplary embodiment of the present invention, scrambling of a DM-RS sequence through additional dynamic control information as well as scrambling of a DM-RS sequence according to n_{SCID} in Equation 1 is introduced. Different from the foregoing exemplary embodiment using semi-static information n_{RNTI}, in the method of generating a DM-RS according to the second exemplary embodiment, various DM-RS sequences for a DAS may be generated by simultaneously performing DM-RS scrambling through dynamic control information and designation of a DM-RS antenna port. The scrambling of the DM-RS sequence through dynamic control information is introduced to valuably prevent collision when different distributed antennas simultaneously use the same DM-RS sequence compared to a case of using the semi-static.

As described above, the LTE-A supports two types of DM-RS sequences using n_{SCID} having 1 or 0. To this end, three bits among the downlink control information is defined by Table 2.

TABLE 2

| One Codeword | | Two Codewords | |
|---|---|---|---|
| Value | Message | Value | Message |
| 0 | 1 layer, port 7, nSCID = 0 | 0 | 2 layers, ports 7-8, nSCID = 0 |
| 1 | 1 layer, port 7, nSCID = 1 | 1 | 2 layers, ports 7-8, nSCID = 1 |
| 2 | 1 layer, port 8, nSCID = 0 | 2 | 3 layers, ports 7-9 |
| 3 | 1 layer, port 8, nSCID = 1 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

If not specified in Table 2, n_{SCID} is substantially set to ‘0’.

In the method of generating a DM-RS according to the second exemplary embodiment of the present invention, in order to support the DM-RS which is simultaneously transmitted through more distributed antennas, n_{SCID} is sufficiently used and a new parameter n_{SCID2} may be additionally introduced. More types of the DM-RS sequences are ensured by limiting the number of available layers for information to be transmitted through a distributed antenna. If the number of available layers through the distributed antenna is limited to four, the DM-RS may be generated using Table 3A.

TABLE 3A

| value | One CW | | Two CW | |
|---|---|---|---|---|
| 0 | 1 layer, port 7, nSCID = 0 | nSCID2 = 0 | 2 layer, port 7-8, nSCID = 0 | nSCID2 = 0 |
| 1 | 1 layer, port 7, nSCID = 1 | | 2 layer, port 7-8, nSCID = 1 | |
| 2 | 1 layer, port 8, nSCID = 0 | | 3 layer, port 7-9, nSCID = 0 | |
| 3 | 1 layer, port 8, nSCID = 1 | | 3 layer, port 7-9, nSCID = 1 | |
| 4 | 2 layer, port 7-8, nSCID = 0 | | 4 layer, port 7-10, nSCID = 0 | |
| 5 | 2 layer, port 7-8, nSCID = 1 | | 4 layer, port 7-10, nSCID = 1 | |
| 6 | 3 layer, port 7-9, nSCID = 0 | | 5 layer, port 7-11, nSCID = 0 | |
| 7 | 4 layer, port 7-10, nSCID = 0 | | 6 layer, port 7-12, nSCID = 0 | |
| 8 | 1 layer, port 7, nSCID = 0 | nSCID2 = 1 | 7 layer, port 7-13, nSCID = 0 | |
| 9 | 1 layer, port 7, nSCID = 1 | | 8 layer, port 7-14, nSCID = 0 | |
| 10 | 1 layer, port 8, nSCID = 1 | | 2 layer, port 7-8, nSCID = 0 | nSCID2 = 1 |
| 11 | 1 layer, port 8, nSCID = 0 | | 2 layer, port 7-8, nSCID = 1 | |
| 12 | 2 layer, port 7-8, nSCID = 0 | | 3 layer, port 7-9, nSCID = 0 | |
| 13 | 2 layer, port 7-8, nSCID = 1 | | 3 layer, port 7-9, nSCID = 1 | |
| 14 | 3 layer, port 7-9, nSCID = 0 | | 4 layer, port 7-10, nSCID = 0 | |
| 15 | 4 layer, port 7-10, nSCID = 0 | | 4 layer, port 7-10, nSCID = 1 | |

In Table 2 being a case of LTE-A, when one codeword is transmitted through two layers and when two codewords are transmitted to three or four layers, n_{SCID} is only 0. That is because n_{SCID} is designed in consideration of only a characteristic of an MU-MIMO of a LTE-A system. However, in a case of the DAS, since n_{SCID} may be sufficiently used within the limited number of layers in the distributed antenna, a case that n_{SCID} is 1 is added to Table 3A. The various number of DM-RS sequences may be ensured by additionally introducing n_{SCID2}.

In a case of Table 3A, since the number of layers transmitted to the distributed antenna is limited to four but equipment cost of the distributed antennas needs to be reduced, only a limited number of layers may be supported. If the number of layers through the distributed antenna is limited to two, a DM-RS may be generated using Table 4.

TABLE 4

| value | One CW | | Two CW | |
|---|---|---|---|---|
| 0 | 1 layer, port 7, nSCID = 0 | nSCID2 = 0 | 2 layer, port 7-8, nSCID = 0 | nSCID2 = 0 |
| 1 | 1 layer, port 7, nSCID = 1 | | 2 layer, port 7-8, nSCID = 1 | |
| 2 | 1 layer, port 8, nSCID = 0 | | 3 layer, port 7-9, nSCID = 0 | |
| 3 | 1 layer, port 8, nSCID = 1 | | 4 layer, port 7-10, nSCID = 0 | |
| 4 | 2 layer, port 7-8, nSCID = 0 | | 5 layer, port 7-11, nSCID = 0 | |
| 5 | 2 layer, port 7-8, nSCID = 1 | | 6 layer, port 7-12, nSCID = 0 | |
| 6 | 3 layer, port 7-9, nSCID = 0 | | 7 layer, port 7-13, nSCID = 0 | |
| 7 | 4 layer, port 7-10, nSCID = 0 | | 8 layer, port 7-14, nSCID = 0 | |
| 8 | 1 layer, port 7, nSCID = 0 | nSCID2 = 1 | 2 layer, port 7-8, nSCID = 0 | nSCID2 = 1 |
| 9 | 1 layer, port 7, nSCID = 1 | | 2 layer, port 7-8, nSCID = 1 | |
| 10 | 1 layer, port 8, nSCID = 0 | | 2 layer, port 7-8, nSCID = 0 | nSCID2 = 2 |
| 11 | 1 layer, port 8, nSCID = 1 | | 2 layer, port 7-8, nSCID = 1 | |
| 12 | 1 layer, port 7, nSCID = 0 | nSCID2 = 2 | 2 layer, port 7-8, nSCID = 0 | nSCID2 = 3 |
| 13 | 1 layer, port 7, nSCID = 1 | | 2 layer, port 7-8, nSCID = 1 | |
| 14 | 1 layer, port 8, nSCID = 0 | | 2 layer, port 7-8, nSCID = 0 | nSCID2 = 4 |
| 15 | 1 layer, port 8, nSCID = 1 | | 2 layer, port 7-8, nSCID = 1 | |

In a case of Table 4, by limiting the number of layers through the distributed antenna, the possible number of n_{SCID2} by adding one bit when transmitting two codewords may be increased to 5. In consideration of a fact that a case where one codeword is transmitted to a plurality of layers in the LTE or LTE-A system corresponds to a case of retransmission, when one codeword is transmitted, n_{SCID2} is expanded with respect to only one layer so that three type of n_{SCID2} may be ensured. For example, additional n_{SCID2} may be used except that the central antenna generates initial transmission and the distributed antenna generates retransmission.

When generating the DM-RS using Table 3A or Table 4, the DM-RS sequence is generated using Equation 7.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 12 {N}_{RB}^{ma x , DL} - 1 \qquad Equation 7$$

In Equation 7, c(i) is a pseudo-random sequence, and an initial value with respect to a generator of the pseudo-random sequence is defined as illustrated in Equation 8.

cᵢₙᵢₜ=(└nₛ/2┘+1)·(2N_{ID}^{cell}+1)·2¹⁶+f(n_{SCID},n_{SCID2}) Equation 8

In Equation 8, ƒ(n_{SCID},n_{SCID2}) is a function for generating a value obtained by combining n_{SCID2} with n_{SCID}. An example of the function ƒ(n_{SCID},n_{SCID2}) is a previously determined function, n_{SCID2}·2+n_{SCID} and may be a function determined according one value which a base station transmits to the UE through a Radio Resource Control (RRC) signal. An example of a function determined through the RRC signal is described according to a case of Table 3A. The base station transfers four values mapped with respect to a combination of fourth n_{SCID} and n_{SCID2} to the UE through an RRC signal as illustrated in Table 3B, and the UE confirms a combination of n_{SCID} and n_{SCID2} scheduled through the downlink control information, and confirms a mapping value among four values received through the RRC signal through Table 3B. Thereafter, the UE determines a function ƒ(n_{SCID},n_{SCID2}) using values mapped to one of four values received through the RRC signal, and applies Equation 8 to determine cᵢₙᵢₜ used for DM-RS transmission. Each element of a sequence pair transferred to an RRC corresponding to (n_{SCID},n_{SCID2}) in Table 3B correspond to an integer of 0 or greater. A ƒ(n_{SCID},n_{SCID2})=(└nₛ/2┘+1)·(−2N_{ID}^{cell}+2X)·2¹⁶+Y may be considered as an example of ƒ(n_{SCID},n_{SCID2}) corresponding to (X, Y) of Table 3B. This has an effect such that a parameter N_{ID}^{cell} of Equation 2 determining cᵢₙᵢₜ for DM-RS of an existing LTE-A is substituted by X, and n_{SCID} is substituted by Y. In addition, among a combination of (X, Y) in Table 3B, only X may be transfer to the UE through the RRC signal, Y has a fixed value, that is, Y=n_{SCID}.

TABLE 3B

| (n_{SCID}, n_{SCID2}) | (X, Y) |
|---|---|
| (0, 0) | (X0, Y0) |
| (0, 1) | (X1, Y1) |
| (1, 0) | (X2, Y2) |
| (1, 1) | (X3, Y3) |

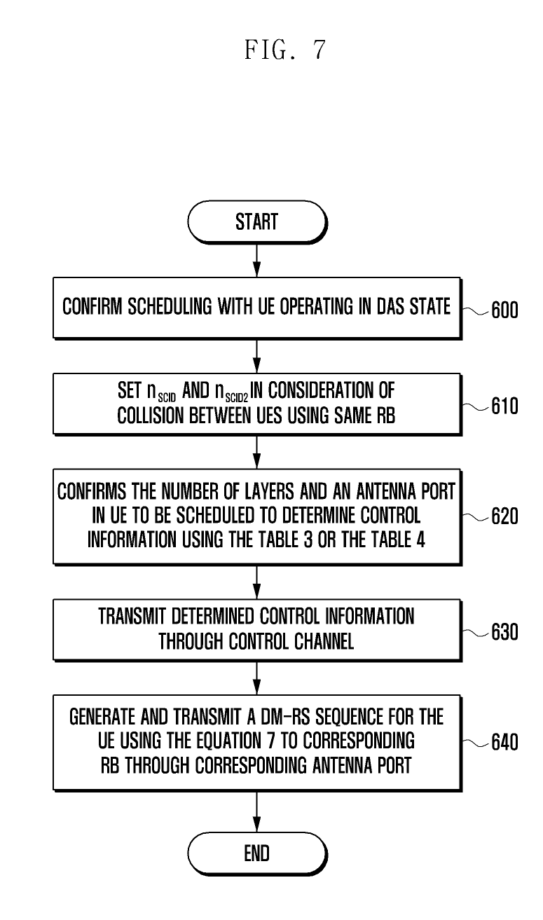

FIG. 7 is a flowchart illustrating a procedure of generating a DM-RS sequence of a base station according to a second exemplary embodiment of the present invention.

Referring to FIG. 7, a base station confirms scheduling with a UE operating in a DAS state at step 600. For example, the base station confirms UEs to be scheduled corresponding to antennas, respectively. The base station determines scrambling variables corresponding to the UE in consideration of collision between UEs using the same RB as that of the UE to be scheduled at step 610. For example, the base station sets n_{SCID} and n_{SCID2} as the scrambling variables. The base station confirms the number of layers in the UE and an antenna port to be scheduled to determine control information using Table 3A or Table 4 at step 620. For example, the base station determines the control information using the scrambling variables, the number of layers, and the antenna port.

Thereafter, the base station transmits the determined control information to the UE through a control channel at step 630. After that, the base station generates a DM-RS sequence for the UE using Equation 7 and transmits the generated DM-RS to a corresponding RB through a corresponding antenna port at step 640, and a procedure of generating and transmitting the DM-RS is terminated. For example, the base station combines n_{SCID2} with n_{SCID} to generate and transmit the DM-RS for a corresponding UE.

### Third Exemplary Embodiment

In the method of generating the DM-RS according to the third exemplary embodiment of the present invention, what is different from the second exemplary embodiment is to ensure additional n_{SCID2} using a New Data Indicator (NDI) with respect to an inactivated codeword which is not used when transmitting one codeword. In the method of generating the DM-RS according to the third exemplary embodiment of the present invention, if the number of available layers through the distributed antenna is limited to four, the DM-RS may be generated using Table 5.

TABLE 5

| value | One CW | | Two CW | |
|---|---|---|---|---|
| 0 | 1 layer, port 7, nSCID = 0 | nSCID2 = 0 | 2 layer, port 7-8, nSCID = 0 | nSCID2 = 0 |
| 1 | 1 layer, port 7, nSCID = 1 | | 2 layer, port 7-8, nSCID = 1 | |
| 2 | 1 layer, port 8, nSCID = 0 | | 3 layer, port 7-9, nSCID = 0 | |
| 3 | 1 layer, port 8, nSCID = 1 | | 3 layer, port 7-9, nSCID = 1 | |
| 4 | 2 layer, port 7-8, nSCID = 0 | | 4 layer, port 7-10, nSCID = 0 | |
| 5 | 2 layer, port 7-8, nSCID = 1 | | 4 layer, port 7-10, nSCID = 1 | |
| 6 | 3 layer, port 7-9, nSCID = 0 | | 5 layer, port 7-11, nSCID = 0 | |
| 7 | 4 layer, port 7-10, nSCID = 0 | | 6 layer, port 7-12, nSCID = 0 | |
| 8 | 1 layer, port 7, nSCID = 0 | nSCID2 = 1 | 7 layer, port 7-13, nSCID = 0 | |
| 9 | 1 layer, port 7, nSCID = 1 | | 8 layer, port 7-14, nSCID = 0 | |
| 10 | 1 layer, port 8, nSCID = 1 | | 2 layer, port 7-8, nSCID = 0 | nSCID2 = 1 |
| 11 | 1 layer, port 8, nSCID = 0 | | 2 layer, port 7-8, nSCID = 1 | |
| 12 | 2 layer, port 7-8, nSCID = 0 | | 3 layer, port 7-9, nSCID = 0 | |
| 13 | 2 layer, port 7-8, nSCID = 1 | | 3 layer, port 7-9, nSCID = 1 | |
| 14 | 1 layer, port 7, nSCID = 0 | nSCID2 = 2 | 4 layer, port 7-10, nSCID = 0 | |
| 15 | 1 layer, port 7, nSCID = 1 | | 4 layer, port 7-10, nSCID = 1 | |
| 16 | 1 layer, port 8, nSCID = 1 | | N/A | |
| 17 | 1 layer, port 8, nSCID = 0 | | | |
| 18 | 2 layer, port 7-8, nSCID = 0 | | | |
| 19 | 2 layer, port 7-8, nSCID = 1 | | | |
| 20 | 1 layer, port 7, nSCID = 0 | nSCID2 = 3 | | |
| 21 | 1 layer, port 7, nSCID = 1 | | | |
| 22 | 1 layer, port 8, nSCID = 1 | | | |
| 23 | 1 layer, port 8, nSCID = 0 | | | |
| 24 | 2 layer, port 7-8, nSCID = 0 | | | |
| 25 | 2 layer, port 7-8, nSCID = 1 | | | |
| 26 | 1 layer, port 7, nSCID = 0 | nSCID2 = 4 | | |
| 27 | 1 layer, port 7, nSCID = 1 | | | |
| 28 | 1 layer, port 8, nSCID = 1 | | | |
| 29 | 1 layer, port 8, nSCID = 0 | | | |
| 30 | 2 layer, port 7-8, nSCID = 0 | | | |
| 31 | 2 layer, port 7-8, nSCID = 1 | | | |

In a case of Table 5, when one codeword is transmitted, 5 types of n_{SCID2} may be ensured using an NDI bit with respect to an inactivated codeword which is not used in the LTE-A. In consideration of a fact that a case where one codeword is transmitted to a plurality of layers in the LTE or LTE-A system corresponds to a case of retransmission, when one codeword is transmitted, n_{SCID2} may be expanded with respect to only one or two layers. For example, additional n_{SCID2} may be used except that the central antenna generates initial transmission and the distributed antenna generates retransmission.

In a case of Table 5, the number of layers transmitted to the distributed antenna is limited to four. However, if the number of layers through the distributed antenna is limited to two, the DM-RS may be generated using Table 6.

TABLE 6

| value | One CW | | Two CW | |
|---|---|---|---|---|
| 0 | 1 layer, port 7, nSCID = 0 | nSCID2 = 0 | 2 layer, port 7-8, nSCID = 0 | nSCID2 = 0 |
| 1 | 1 layer, port 7, nSCID = 1 | | 2 layer, port 7-8, nSCID = 1 | |
| 2 | 1 layer, port 8, nSCID = 0 | | 3 layer, port 7-9, nSCID = 0 | |
| 3 | 1 layer, port 8, nSCID = 1 | | 4 layer, port 7-10, nSCID = 0 | |
| 4 | 2 layer, port 7-8, nSCID = 0 | | 5 layer, port 7-11, nSCID = 0 | |
| 5 | 2 layer, port 7-8, nSCID = 1 | | 6 layer, port 7-12, nSCID = 0 | |
| 6 | 3 layer, port 7-9, nSCID = 0 | | 7 layer, port 7-13, nSCID = 0 | |
| 7 | 4 layer, port 7-10, nSCID = 0 | | 8 layer, port 7-14, nSCID = 0 | |
| 8 | 1 layer, port 7, nSCID = 0 | nSCID2 = 1 | 2 layer, port 7-8, nSCID = 0 | nSCID2 = 1 |
| 9 | 1 layer, port 7, nSCID = 1 | | 2 layer, port 7-8, nSCID = 1 | |
| 10 | 1 layer, port 8, nSCID = 1 | | 2 layer, port 7-8, nSCID = 0 | nSCID2 = 2 |
| 11 | 1 layer, port 8, nSCID = 0 | | 2 layer, port 7-8, nSCID = 1 | |
| 12 | 1 layer, port 7, nSCID = 0 | nSCID2 = 2 | 2 layer, port 7-8, nSCID = 0 | nSCID2 = 3 |
| 13 | 1 layer, port 7, nSCID = 1 | | 2 layer, port 7-8, nSCID = 1 | |
| 14 | 1 layer, port 8, nSCID = 1 | | 2 layer, port 7-8, nSCID = 0 | nSCID2 = 4 |
| 15 | 1 layer, port 8, nSCID = 0 | | 2 layer, port 7-8, nSCID = 1 | |
| 16 | 1 layer, port 7, nSCID = 0 | nSCID2 = 3 | N/A | |
| 17 | 1 layer, port 7, nSCID = 1 | | | |
| 18 | 1 layer, port 8, nSCID = 1 | | | |
| 19 | 1 layer, port 8, nSCID = 0 | | | |
| 20 | 1 layer, port 7, nSCID = 0 | nSCID2 = 4 | | |
| 21 | 1 layer, port 7, nSCID = 1 | | | |
| 22 | 1 layer, port 8, nSCID = 1 | | | |
| 23 | 1 layer, port 8, nSCID = 0 | | | |
| 24 | 1 layer, port 7, nSCID = 0 | nSCID2 = 5 | | |
| 25 | 1 layer, port 7, nSCID = 1 | | | |
| 26 | 1 layer, port 8, nSCID = 1 | | | |
| 27 | 1 layer, port 8, nSCID = 0 | | | |
| 28 | 1 layer, port 7, nSCID = 0 | nSCID2 = 6 | | |
| 29 | 1 layer, port 7, nSCID = 1 | | | |
| 30 | 1 layer, port 8, nSCID = 1 | | | |
| 31 | 1 layer, port 8, nSCID = 0 | | | |

In a case of Table 6, as in the case of Table 5, when one codeword is transmitted, additional n_{SCID2} may be ensured using an NDI bit with respect to an inactivated codeword which is not used in the LTE-A. For example, additional n_{SCID2} may be used except that the central antenna generates initial transmission and the distributed antenna generates retransmission.

If the number of layers through the distributed antenna is limited to one, the DM-RS may be generated using Table 7A.

TABLE 7A

| | One CW | | Two CW |
|---|---|---|---|
| 0 | 1 layer, port 7, nSCID = 0 | nSCID2 = 0 | 2 layer, port 7-8, SCID = 0 |
| 1 | 1 layer, port 7, nSCID = 1 | | 2 layer, port 7-8, SCID = 1 |
| 2 | 1 layer, port 8, nSCID = 0 | | 3 layer, port 7-9, SCID = 0 |
| 3 | 1 layer, port 8, nSCID = 1 | | 4 layer, port 7-10, SCID = 0 |
| 4 | 2 layer, port 7-8, nSCID = 0 | | 5 layer, port 7-11, SCID = 0 |
| 5 | 2 layer, port 7-8, nSCID = 1 | | 6 layer, port 7-12, SCID = 0 |
| 6 | 3 layer, port 7-9, nSCID = 0 | | 7 layer, port 7-13, SCID = 0 |
| 7 | 4 layer, port 7-10, nSCID = 0 | | 8 layer, port 7-14, SCID = 0 |
| 8 | 1 layer, port 7, nSCID = 0 | nSCID2 = 1 | N/A |
| 9 | 1 layer, port 7, nSCID = 1 | | |
| 10 | 1 layer, port 8, nSCID = 0 | | |
| 11 | 1 layer, port 8, nSCID = 1 | | |
| 12 | 1 layer, port 7, nSCID = 0 | nSCID2 = 2 | |
| 13 | 1 layer, port 7, nSCID = 1 | | |
| 14 | 1 layer, port 8, nSCID = 0 | | |
| 15 | 1 layer, port 8, nSCID = 1 | | |

In a case of Table 7A, as in the case of Table 6, when one codeword is transmitted, additional n_{SCID2} may be ensured using an NDI bit with respect to an inactivated codeword which is not used in the LTE-A. In a case of Table 7A, since three types of n_{SCID2} may be used with only three bits, a DM-RS sequence considering the DAS may be additionally used without using an additional bit with respect to the LTE-A.

In this exemplary embodiment, an initial value for a DM-RS sequence is determined as illustrated in Equation 8, an example of the function ƒ(n_{SCID},n_{SCID2}) may be a previously determined function like n_{SCID2}·2+n_{SCID}, or a function determined according to at least one value transferred to the UE through an RRC signal. An example of a function determined through the RRC signal is described using a case of Table 7A. The base station transfers six values mapped with respect to a combination of four types of n_{SCID} and n_{SCID2} to the UE through the RRC signal as illustrated in Table 7B, and the UE confirms a combination of the scheduled n_{SCID} and n_{SCID2} through a received downlink control information, and one mapping value among the six values received through the RRC signal. Thereafter, the terminal determines a function ƒ(n_{SCID},n_{SCID2}) using the one mapping value among the six values transferred through the RRC signal, and applies the function to Equation 8 to determine cᵢₙᵢₜ used for DM-RS transmission. Each element of a sequence pair transferred to an RRC corresponding to (n_{SCID},n_{SCID2}) in Table 3A corresponds to an integer of 0 or greater. A ƒ(n_{SCID},n_{SCID2})=(└nₛ/2┘+1)·(−2N_{ID}^{cell}+2X)·2¹⁶+Y may be considered as an example of ƒ(n_{SCID},n_{SCID2}) corresponding to (X,Y) of Table 7B. This has an effect such that a parameter N_{ID}^{cell} of Equation 2 determining cᵢₙᵢₜ for DM-RS of an existing LTE-A is substituted by X, and n_{SCID} is substituted by Y.

In addition, among a combination of (X, Y) in Table 7B, only X may be transferred to the UE through the RRC signal, Y has a fixed value, that is, Y=n_{SCID}.

TABLE 7B

| (n_{SCID}, n_{SCID2}) | (X, Y) |
|---|---|
| (0, 0) | (X0, Y0) |
| (0, 1) | (X1, Y1) |
| (0, 2) | (X2, Y2) |
| (1, 0) | (X3, Y3) |
| (1, 1) | (X4, Y4) |
| (1, 2) | (X5, Y5) |

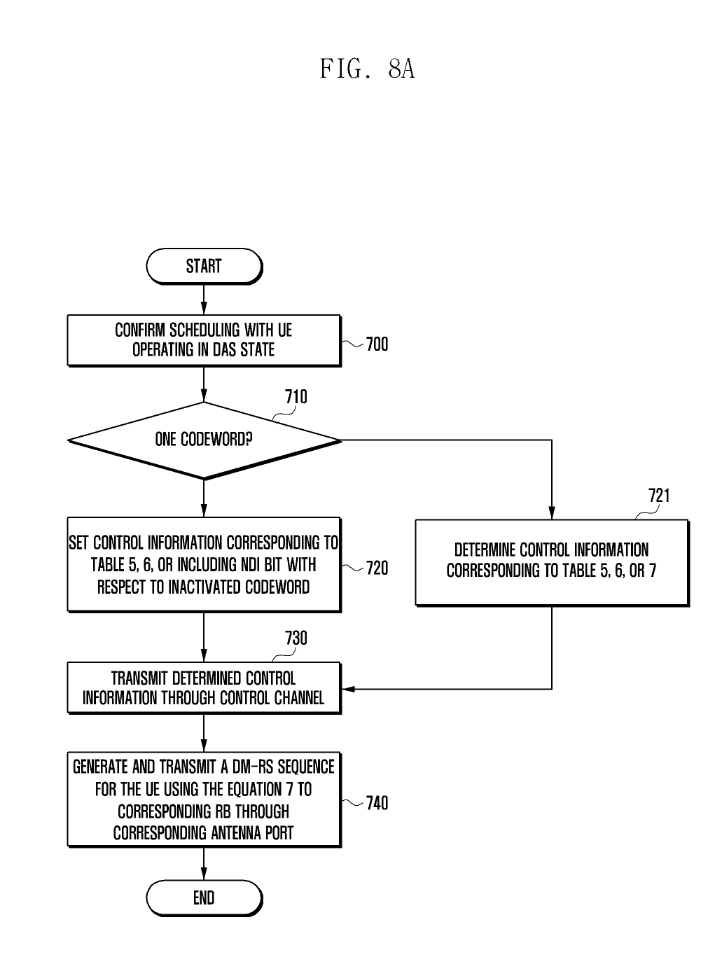

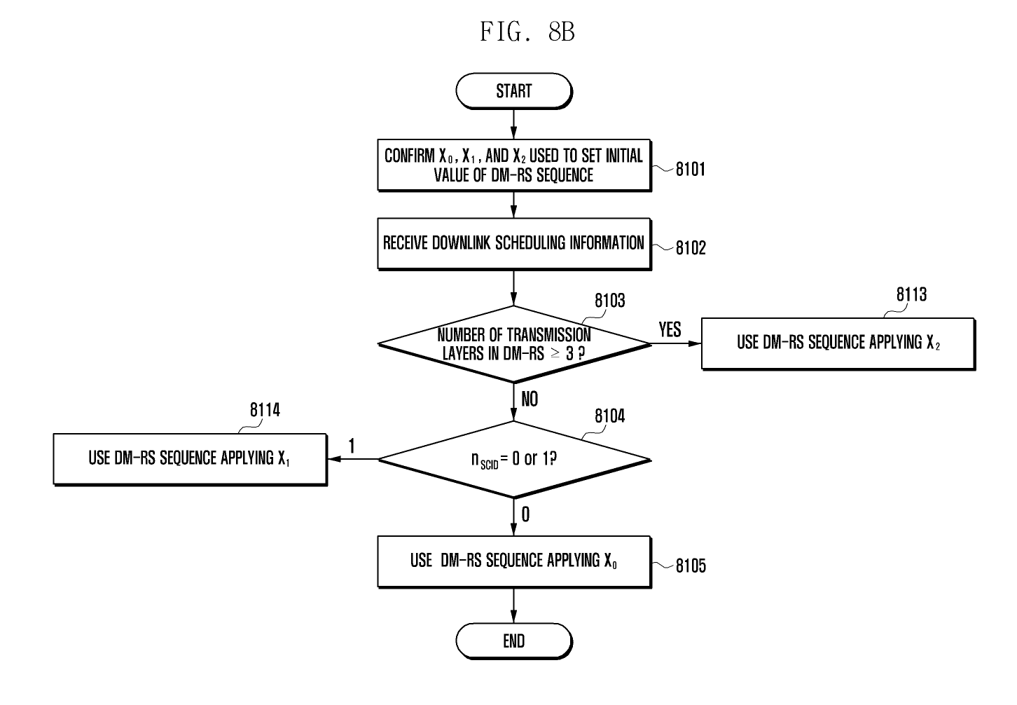

FIG. 8A is a flowchart illustrating a procedure of generating a DM-RS sequence of a base station according to a third exemplary embodiment of the present invention.

Referring to FIG. 8A, a base station confirms scheduling with a UE operating in a DAS state at step 700. For example, the base station confirms UEs to be scheduled corresponding to antennas, respectively. The base station confirms the number of codewords to be transmitted to a UE to be scheduled at step 710. In this case, the base station may determine scrambling variables corresponding to a UE in consideration of collision of UEs using the same RB with a UE to be scheduled. For example, the base station may set n_{SCID} and n_{SCID2} as scrambling variables. If the number of codewords is one at step 710, the base station sets control information corresponding to Table 5, Table 6, or Table 7A in consideration of collision of UEs using the same RB with the UE to be scheduled including an NDI bit with respect to an inactivated codeword at step 720. In this case, the base station may confirm the number of layers in the UE to be scheduled and an antenna port. The base station may determine control information using the scrambling variables, the number of layers, and the antenna port. If the number of codewords is two at step 710, the base station sets control information corresponding to Table 5, Table 6, or Table 7A in consideration of collision of UEs without an NDI bit and using an RB at step 721.

Thereafter, the base station transmits the determined control information to the UE through a control channel at step 730. After that, the base station generates a DM-RS for a UE using Equation 7 and transmits the generated DM-RS to a corresponding RB through a corresponding antenna port at step 740, and a procedure of generating and transmitting the DM-RS is terminated. For example, the base station combines n_{SCID2} with n_{SCID} to generate and transmit the DM-RS for a corresponding UE. In this case, the UE having received the control information determines whether the number of codewords is one or two, and confirms control information corresponding to Table 5, Table 6, or Table 7A by setting presence of inclusion of the NDI bit with respect to each case.

Meanwhile, the foregoing exemplary embodiments have illustrated an example of combining [n_{RNTI} mod G] or n_{SCID2} with n_{SCID} to generate a DM-RS sequence for the UE by the base station. For example, the base station may combine [n_{RNTI} mod G] or n_{SCID2} with n_{SCID} to generate a DM-RS sequence for the UE. For example, the base station combines at least one of [n_{RNTI} mod G] and n_{SCID2} with n_{SCID} to generate the DM-RS sequence so that exemplary embodiments of the present invention may be implemented.

### Fourth Exemplary Embodiment

In the method of generating the DM-RS according to the fourth exemplary embodiment of the present invention, different from identifying a DM-RS from various distributed antennas by adding a new DM-RS sequence, what is different from the foregoing exemplary embodiments is to identify a DM-RS using orthogonal resources which are not used in the LTE-A in a DAS state.

In the LTE-A, when a codeword is transmitted to 1, 2, 3, and 4 layers, a Spreading Factor (SF) of an orthogonal sequence is set to 2, and only DM-RS ports 7 to 10 among DM-RS ports 7 to 13 are used. If the UE sets the SF of the orthogonal sequence to 4 to detect the DM-RS, the DM-RS ports 11 to 13 are orthogonal to the DM-RS ports 7 to 10. Accordingly, if an orthogonal resource which are not used in the LTE-A in a specific layer state is additionally used after the SF is set to 4 in a DAS state, more distributed antennas may be supported. For example, in the fourth exemplary embodiment of the present invention, the number of layers available through the distributed antenna is set to 4 and the DM-RS is generated according to Table 8.

TABLE 8

| | One CW | Two CW |
|---|---|---|
| 0 | 1 layer, port 7, nSCID = 0 | 2 layer, port 7-8, nSCID = 0 |
| 1 | 1 layer, port 7, nSCID = 1 | 2 layer, port 7-8, nSCID = 1 |
| 2 | 1 layer, port 8, nSCID = 0 | 3 layer, port 7-9, nSCID = 0 |
| 3 | 1 layer, port 8, nSCID = 1 | 3 layer, port 7-9, nSCID = 1 |
| 4 | 2 layer, port 7-8, nSCID = 0 | 4 layer, port 7-10, nSCID = 0 |
| 5 | 2 layer, port 7-8, nSCID = 1 | 4 layer, port 7-10, nSCID = 1 |
| 6 | 3 layer, port 7-9, nSCID = 0 | 5 layer, port 7-11, nSCID = 0 |
| 7 | 4 layer, port 11, nSCID = 0 | 6 layer, port 7-12, nSCID = 0 |
| 8 | 1 layer, port 11, nSCID = 0 | 7 layer, port 7-13, nSCID = 0 |
| 9 | 1 layer, port 11, nSCID = 1 | 8 layer, port 7-14, nSCID = 0 |
| 10 | 1 layer, port 13, nSCID = 0 | 2 layer, port 11, 13, nSCID = 0 |
| 11 | 1 layer, port 13, nSCID = 1 | 2 layer, port 11, 13, nSCID = 1 |
| 12 | 2 layer, port 11, 13, nSCID = 0 | 3 layer, port 11, 13, nSCID = 0 |
| 13 | 2 layer, port 11, 13, nSCID = 1 | 3 layer, port 11, 13, nSCID = 1 |
| 14 | 3 layer, port 11-13, nSCID = 0 | 4 layer, port 11-14, nSCID = 0 |
| 15 | 4 layer, port 11-14, nSCID = 1 | 4 layer, port 11-14, nSCID = 1 |

The base station sets a DM-RS port and n_{SCID} in consideration of the UEs to be simultaneously scheduled according to Table 8 and transmits control information of 4 bits to the UE and transmits the DM-RS to a corresponding port. When the UE operates in a DAS situation, the UE sets the SF to 4 and receives the DM-RS.

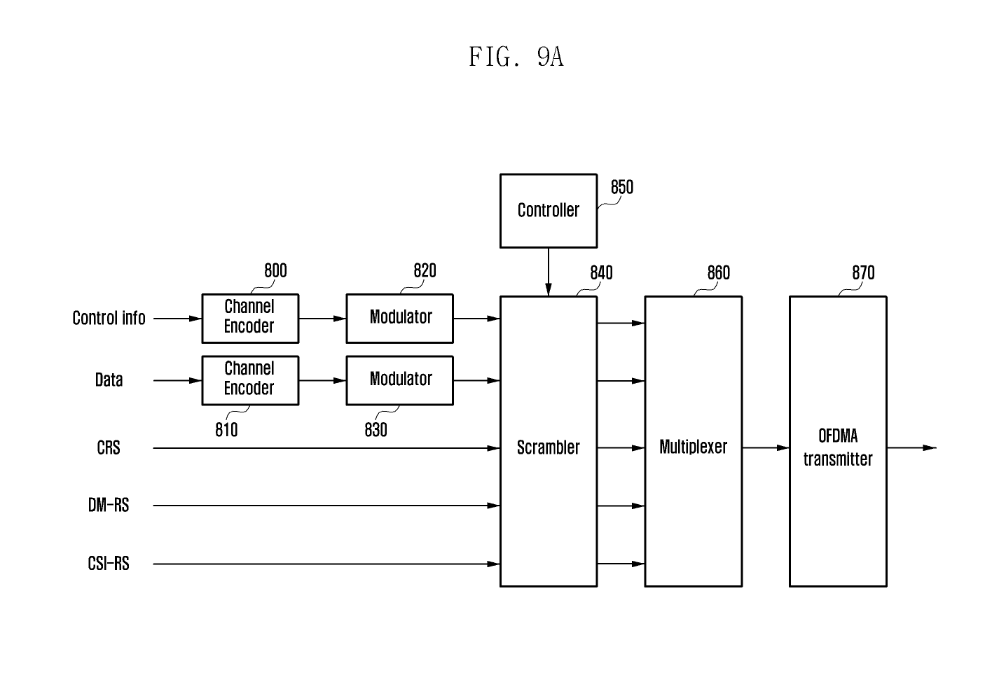

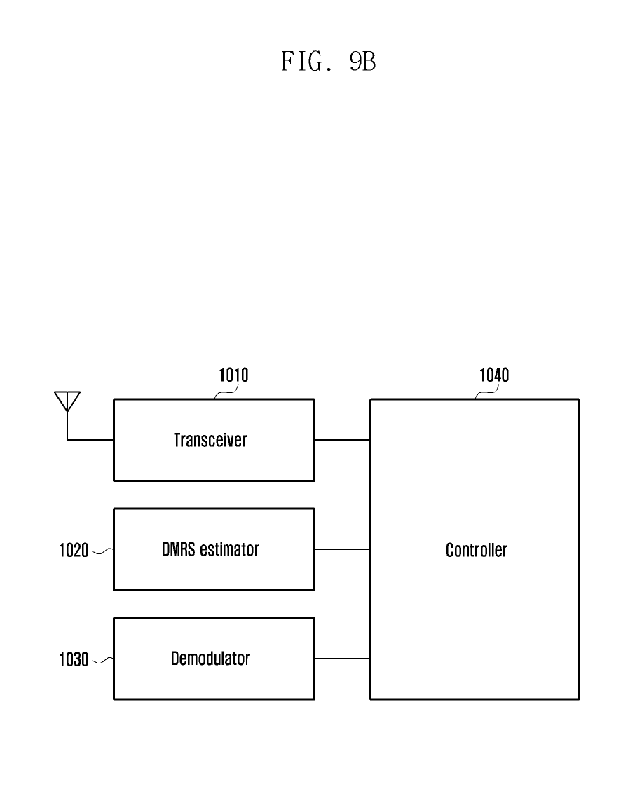

FIG. 9A is a block diagram illustrating a device for generating a DM-RS sequence of a base station according to an exemplary embodiment of the present invention.

### Fifth Exemplary Embodiment

When the DM-RS is generated according to the fifth exemplary embodiment of the present invention, a DM-RS sequence is generated using Equation 9.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 12 {N}_{RB}^{ma x , DL} - 1 \qquad Equation 9$$

In Equation 9, c(i) is a pseudo-random sequence, and an initial value with respect to a generator of the pseudo-random sequence is defined as illustrated in Equation 10.

$${c}_{init} = \{ \begin{matrix}( ⌊ {n}_{s} / 2 ⌋ + 1 ) \cdot ( 2 {X}_{{n}_{SCID}} + 1 ) \cdot {2}^{16} + {n}_{SCID} & \begin{matrix}for 1 or 2 \text{-} layer \\ transmission\end{matrix} \\ ( ⌊ {n}_{s} / 2 ⌋ + 1 ) \cdot ( 2 {X}_{2} + 1 ) \cdot {2}^{16} & \begin{matrix}for more than or equal \\ to 3 \text{-} layer transmission\end{matrix}\end{matrix} \qquad Equation 10$$

In Equation 10, n_{SCID} is transferred through a Physical Downlink Control Channel (PDCCH), and is determined according to downlink dynamic control information indicating DM-RS scrambling, the number of DM-RS layers, and an antenna port included in downlink scheduling information, has 0 or 1, and is determined as illustrated in Table 2. An x₀ and an x₁ with respect to Xₙ_{_{SCID}} used when the number of transmission layers is 1 or 2 is determined within a specific range by the base station and the determined x₀ and x₁ are transferred to the UE through the RRC signal being an upper signal. For example, a range of x₀ and x₁ may be determined as [0, 503] which is a range of N_{ID}^{cell} which is used as the same application in an initial value of a DM-RS sequence in the LTE-A. An x₂ used when the number of transmission layers of the DM-RS is 3 or greater is determined within a specific range by the base station, and the determined x₂ is transferred to the UE through the RRC signal, and may be determined as x₂=n_{RNTI} mod 504 using a unique number n_{RNTI} of the UE allocated by the base station. The 504 is a value set to allow a range of x₂ to have [0, 503]. Exemplary embodiments of the present invention are not limited to the 504, and the range of the x₂ may be the other integer. The reason to differently set an initial value of a DM-RS sequence according to the number of layers in the DM-RS as illustrated in Equation 10 is as follows. As illustrated in Table 2, when the number of the layers is 1 or 2, n_{SCID} may have two values. When the number of the layers is greater than 2, n_{SCID} may have a fixed value. Accordingly, additional DM-RS randomization effect by UEs may not be obtained. In addition, when the number of layers is greater than 3 in the LTE-A system, a MU MIMO is not considered. Accordingly, although only a sufficiently random DM-RS by users may be used, a system performance may be sufficiently obtained.

FIG. 8B is a flowchart illustrating a procedure of generating a DM-RS sequence of a base station according to the fifth exemplary embodiment of the present invention.

Referring FIG. 8B, a UE using an initial value of the DM-RS sequence of Equation 10 confirms X₀, X₁, and X₂ used to set the initial value of the DM-RS sequence at step 8101. The X₀, X₁, and X₂ are used in Equation 10. Thereafter, the UE downlink dynamic control information indicating DM-RS confirms scrambling, the number of DM-RS layers, and an antenna port included in downlink scheduling information to confirm n_{SCID} at step 8102. After that, the UE determines whether the number of transmission layers in the DM-RS is equal to or greater than 3 at step 8103. When the number of transmission layers in the DM-RS is equal to or greater than 3, the UE applies the X₂ to use a DM-RS sequence corresponding to the initial value of the DM-RS sequence at step 8113. When the number of transmission layers in the DM-RS is less than 3 at step 8103, the UE determines whether n_{scid} is 0 or 1 at step 8104. When the n_{SCID} is 0, the UE uses a DM-RS sequence applying X₀ at step 8105. When the n_{SCID} is 1, the UE uses a DM-RS sequence applying X₁ at step 8114.

Referring to FIG. 9A, a base station includes channel encoders 800 and 810, modulators 820 and 830, a scrambler 840, a controller 850, a multiplexer 860, and a transmitter 870.

The channel encoders 800 and 810 perform channel encoding with respect to control information or data. The modulators 820 and 830 modulate the channel-encoded signal in a modulation scheme, such as Quadrature Phase Shift Keying (QPSK), 16 Quadrature Amplitude Modulation (QAM), or 64QAM. The scrambler 840 scrambles the modulated signals Cell-specific Reference Signal (CRS), DM-RS, and Channel State Information-Reference Signal (CSI-RS). In this case, the scrambler 840 scrambles the signal in a sub-frame to a suitable scrambling sequence. The scrambling sequence is determined according to an initial value by signals. The controller 850 determines an initial value of the scrambling sequence by signals and transfers the same to the scrambler 840. The multiplexer 860 frequency and time-multiplexes the signals, and the transmitter 870 transmits the multiplexed signal through a sub-frame in an Orthogonal Frequency Division Multiple Access (OFDMA) scheme. Although this exemplary embodiment illustrates that the multiplexer 860 is located at a rear terminal of the scrambler 850, exemplary embodiments of the present invention are not limited thereto. For example, even if the multiplexer 860 is located at a front terminal of the scrambler 850, exemplary embodiments of the present invention may be implemented.

In this case, the controller 850 determines at least two scrambling variables for each UE corresponding to a plurality of antennas which are distributed at a service area of a base station. In this case, the controller 850 confirms a UE to be scheduled corresponding to the antennas. The controller 850 may determine [n_{RNTI} mod G] as a scrambling variable using n_{RNTI} of the UE and a mod G as a scrambling variable and may determine n_{SCID} as the scrambling variable according to the first exemplary embodiment of the present invention. The controller 850 may determine scrambling variables corresponding to a UE in consideration of the UE and another UE using the same RB according to the second and third exemplary embodiments of the present invention. The controller 850 may determine the number of codewords to be transmitted to the UE according to the third exemplary embodiment of the present invention. If the number of codewords is one, the controller 850 may determine scrambling variables using an NDI bit of an inactivated codeword.

The scrambler 840 combines the scrambling variables with each other to generate DM-RS sequences for the antennas, respectively. In this case, the scrambler 840 may confirm the number of layers in the UE and an antenna port, and determine control information using scrambling variables, the number of layers, and the antenna port.

The transmitter 870 transmits the DM-RS sequence through respective antennas. In this case, when the control information is determined in a sequence generator, the transmitter may transmit the control information to the UE.

Meanwhile, the antennas may use resources where parts of the resources are orthogonal to remaining resources. In this case, when an antenna for a specific UE uses an orthogonal resource, the controller 850 may transmit a control signal for changing SF set in order for the UE to receive the DM-RS sequence from 2 to 4 to the UE. For example, if a DM-RS port of an antenna for the UE corresponds to 11 to 13, the controller 850 may generate and transmit control information to the UE so that the UE sets the SF to 4.

FIG. 9B is a block diagram illustrating a structure of a UE according to an exemplary embodiment of the present invention.

Referring to FIG. 9B, the UE includes a transceiver 1010, a DM-RS estimator 1020, a demodulator 1030, and a controller 1040. The transceiver 1010 enables the UE to transceiver dynamic control information, an upper signal, a reference signal, and data. More particularly, the transceiver 1010 is used to receive a DM-RS, a PDCCH, a Physical Downlink Shared Channel (PDSCH), or the like. The DM-RS estimator 1020 enables the UE to estimate the DM-RS using an antenna port, the number of layers, and sequence information allocated by the base station. The demodulator 1030 demodulates a data channel in consideration of a channel state estimated through the DM-RS. The constituent elements of the UE are operated under control of the controller 1040.

The DAS of a cellular mobile communication system can provide an improved mobile communication service compared to a CAS by uniformly distributing antennas at a service area of a cell. Exemplary embodiments of the present invention efficiently generate a DM-RS to maximize RS resource use in the DAS where antennas operated by each base station are distributed at a service area of a corresponding base station in a cellular mobile communication system having a plurality of base stations. Therefore, since the cellular mobile communication system according to the exemplary embodiment of the present invention efficiently generates and transmits antennas arranged at a center and around the cell, the DM-RS can be transceived with a high data transmission ratio to each UE regardless of locations of UEs arranged in the cell.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of transmitting a reference signal in a mobile communication system, the method comprising:
determining at least three scrambling variables comprising a first scrambling variable, a second scrambling variable, and a third scrambling variable, wherein the first scrambling variable, the second scrambling variable, and the third scrambling variable are different from each other;
determining whether a demodulation reference signal is for more than or equal to 3-layer transmission;
generating, if the demodulation reference signal is for more than or equal to S-layer transmission, the demodulation reference signal sequence using the third scrambling variable; and
transmitting the demodulation reference signal sequence through a corresponding antenna port.

2. The method of claim 1, further comprising:
generating, if the demodulation reference signal is for 1 or 2-layer transmission, the demodulation reference signal sequence using one of the first scrambling variable and the third scrambling variable.

3. The method of claim 1, wherein the determining of the at least three scrambling variables comprises:
identifying a User Equipment (UE) to be scheduled corresponding to the antenna port; and
determining the third scrambling variable using a unique number of the UE.

4. The method of claim 1, further comprising:
transmitting the third scrambling variable through a Radio Resource Control (RRC) signal to the UE.

5. A method of receiving a reference signal by a User Equipment (UE) in a mobile communication system, the method comprising:
determining at least three scrambling variables comprising a first scrambling variable, a second scrambling variable, and a third scrambling variable, wherein the first scrambling variable, the second scrambling variable, and the third scrambling variable are different from each other;
determining whether a demodulation reference signal is for more than or equal to 3-layer transmission;
generating, if the demodulation reference signal is for more than or equal to S-layer transmission, the demodulation reference signal sequence using the third scrambling variable; and
receiving a demodulation reference signal using the demodulation reference signal sequence through a corresponding antenna port.

6. The method of claim 5, further comprising:
generating, if the demodulation reference signal is for 1 or 2-layer transmission, the demodulation reference signal sequence using one of the first scrambling variable and the third scrambling variable.

7. The method of claim 5, wherein the determining of the at least three scrambling variables comprises:
determining the third scrambling variable using a unique number of the UE.

8. The method of claim 5, wherein the determining of the at least three scrambling variables comprises:
determining the third scrambling variable as a variable indicating the third scrambling variable received through a Radio Resource Control (RRC) signal from a base station.

9. An apparatus for transmitting a reference signal in a mobile communication system, the apparatus comprising:
a controller for determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, and generating, if the demodulation reference signal is for more than or equal to 3-layer transmission, the demodulation reference signal sequence using the third scrambling variable; and
a transmitting unit for transmitting the demodulation reference signal sequence through a corresponding antenna port.

10. The apparatus of claim 9, wherein the controller generates, if the demodulation reference signal is for 1 or 2-layer transmission, the demodulation reference signal sequence using one of the first scrambling variable and the third scrambling variable.

11. The apparatus of claim 9, wherein the controller identifies a User Equipment (UE) to be scheduled corresponding to the antenna port, and determines the third scrambling variable using a unique number of the UE.

12. The apparatus of claim 9, wherein the transmitting unit transmits the third scrambling variable through a Radio Resource Control (RRC) signal to the UE.

13. A User Equipment (UE) for receiving a reference signal in a mobile communication system, the UE comprising:
a controller for determining at least three scrambling variables comprising a first scrambling variable, a second scrambling variable, and a third scrambling variable, wherein the first scrambling variable, the second scrambling variable, and the third scrambling variable are different from each other, determining whether a demodulation reference signal is for more than or equal to 3-layer transmission, and generating, if the demodulation reference signal is for more than or equal to 3-layer transmission, the demodulation reference signal sequence using the third scrambling variable; and
a receiving unit for receiving a demodulation reference signal using the demodulation reference signal sequence through a corresponding antenna port.

14. The UE of claim 13, wherein the controller generates, if the demodulation reference signal is for 1 or 2-layer transmission, the demodulation reference signal sequence using one of the first scrambling variable and the third scrambling variable.

15. The UE of claim 13, wherein the controller determines the third scrambling variable using a unique number of the UE.

16. The UE of claim 13, wherein the controller determines the third scrambling variable as a variable indicating the third scrambling variable received through a Radio Resource Control (RRC) signal from a base station.
